(19) United States
(12) Patent Application Publication
(10) Pub. No.: US 2013/0164145 A1
(43) Pub. Date: Jun. 27, 2013

(54) METHOD FOR MANUFACTURING A HOLLOW VANE

(71) Applicant: Thierry Georges Paul PAPIN, Varennes-Jarcy (FR)

(72) Inventor: Thierry Georges Paul PAPIN, Varennes-Jarcy (FR)

(73) Assignee: SNECMA, Paris (FR)

(21) Appl. No.: 13/723,996

(22) Filed: Dec. 21, 2012

(30) Foreign Application Priority Data
Dec. 23, 2011 (FR) 1162402

(51) Int. Cl. B23P 15/04; F01D 5/18

(52) U.S. Cl. CPC B23P 15/04; F01D 5/18
USPC 416/232; 29/889.21

(57) ABSTRACT

A method for manufacturing a hollow structural turbomachine vane, the method including forming a first cavity in a first face of a first block; assembling by diffusion bonding the first block and a second block, the first face of the first block being positioned facing a second face of the second block, the first cavity thus forming a closed cavity; machining the block resulting from the assembly of the first block and the second block so as to obtain a vane including the closed cavity.

### CROSS REFERENCE TO RELATED APPLICATIONS

This application claims priority to French Patent Application No. 1162402, filed Dec. 23, 2011, the content of which is incorporated herein by reference in its entirety.

### FIELD

The field of the invention is, in general, that of aircraft turbojets, and more specifically that of stators. Specifically, the present invention relates to a method for manufacturing a hollow structural vane for a turbojet.

### BACKGROUND

A structural vane is understood to refer to a vane fulfilling the structural conditions enabling it to resist high mechanical stresses, particularly engine loads under all operational conditions. For example, a conventional structural vane is a stator fan vane for a double flow turbojet, also called an “Outlet Guide Vane” (OGV).

One way to limit the mass of turbojet components consists of manufacturing hollow stators. Conventionally, a hollow stator is manufactured according to the following method, illustrated by FIGS. 1 to 3:

A cavity 11 is machined in a conventional stator 12, intrados side. It is noted that the intrados corresponds to the concave face of the stator 12, and the extrados to the convex face. Removal of the material forming the cavity results in a reduction in stator mass.

A low-density filling material 13 is inserted in cavity 11.

To restore the aerodynamic profile of the stator, a plate 14 sealing the cavity 11 is affixed.

The plate 14 is welded onto the stator 12.

It is noted that the function of the filling material 13 is to counter the vibrational modes of plate 14.

This method presents disadvantages connected to welding, for example the presence of a weld bead on the stator that disrupts the flow of the air flow.

### SUMMARY

An aspect of the invention offers a solution to the disadvantages that have just been mentioned, by proposing a method for manufacturing a hollow stator presenting a substantially continuous external surface.

According to a first aspect, there is provided a method for manufacturing a hollow structural vane of a turbomachine, said method comprising:
the formation of a first cavity in a first face of a first block;
the assembly by diffusion bonding of the first block and a second block, the first face of the first block being positioned facing a second face of the second block, the first cavity thus forming a closed cavity;
the machining of the block resulting from the assembly of the first block and the second block so as to obtain a vane comprising the closed cavity.

Closed cavity is understood to refer to a cavity that is isolated from the outside of the vane, into which no fluid may be introduced. The vane comprising the closed cavity is then hollow, since it comprises an inner space empty of matter. The presence of the closed cavity enables the mass of the vane to be reduced. In addition, the cavity does not impact the aerodynamic profile of the vane since the air circulating around the vane cannot penetrate into the closed cavity.

The cavity beneficially has a given form and volume so as to obtain a compromise between the desired mass reduction and good structural strength of the stator.

Thanks to the method according to an aspect of the invention, the defects linked to the assembly of the first block and the second block are removed by the procedure of machining the resulting block.

In addition to the principal characteristics that have just been mentioned in the previous paragraph, the method according to an embodiment of the invention may present one or more additional characteristics from the following, considered individually or according to all technically feasible combinations:

the method comprises prior to the assembly procedure, forming a second cavity in the second face of the second block;

the first cavity and/or the second cavity are formed by machining;

the profile of the closed cavity and the profile of the vane are substantially identical;

the method comprises prior to the assembly procedure:
forming a first groove on an upper part of the first face of the first block, and
forming a second groove on an upper part of the second face of the second block,
   said first groove and second groove being positioned facing each other during the assembling of the first block and the second block, so as to form a throat.

the method comprises prior to the machining procedure:
positioning a gauge in the throat formed by the first groove and the second groove;
palpation of the gauge by a machining tool.

the assembly is carried out by brazing, electron bombardment welding (E.B.), or by linear friction welding;

the method comprises machining a first end part of the first block and a second end part of the second block, such that said first end part covers said second end part such that the leading edge presents a continuous surface;

a mounting surface between the first end part and the second end part presents a step-like form;

the method comprises machining at least one projecting part in the first block, said at least one projecting part extending substantially orthogonally to the plane along which the first block extends;

the method comprises producing a stiffener in the first block and/or in the second block.

According to a second aspect of the invention, there is provided a turbomachine vane comprising an inner cavity delimited by a first intrados side and a second extrados side, the vane presenting a substantially continuous external surface, contrary to the vane from the prior art described previously, that would present a weld bead on its external surface.

Embodiments of the invention and its various applications will be better understood upon reading the following description and examining the accompanying figures.

### BRIEF DESCRIPTION OF THE FIGURES

The figures are only presented for indicative purposes and in no way limit the invention.

The figures show:

FIG. 1, already described, is a blow-up view of a hollow stator according to the prior art;

FIG. 2, already described, is a representation of the assembled hollow stator from FIG. 1;

FIG. 3, already described, is a schematic representation of a part of the assembled hollow stator from FIG. 1;

FIG. 4 is a diagram illustrating a method for manufacturing a hollow vane according to an embodiment of the invention;

FIG. 5 is an illustration of a machining of two blocks, according to an embodiment of the method;

FIG. 6 is an illustration of assembling blocks, according to an embodiment of the method;

FIG. 7 is an enlargement of a part from FIG. 6;

FIG. 8 is an illustration of a machining of the assembled blocks, according to an embodiment of the method;

FIG. 9 is a schematic representation of a vane produced from the method according to an embodiment;

FIG. 10 is a cross sectional view of the vane from FIG. 9;

FIG. 11 is a schematic representation of a vane produced from the method according to an embodiment of the method;

FIG. 12 is an illustration of machining two blocks, according to an embodiment of the method;

FIG. 13 is an illustration of a ribbed vane produced from the method according to an embodiment.

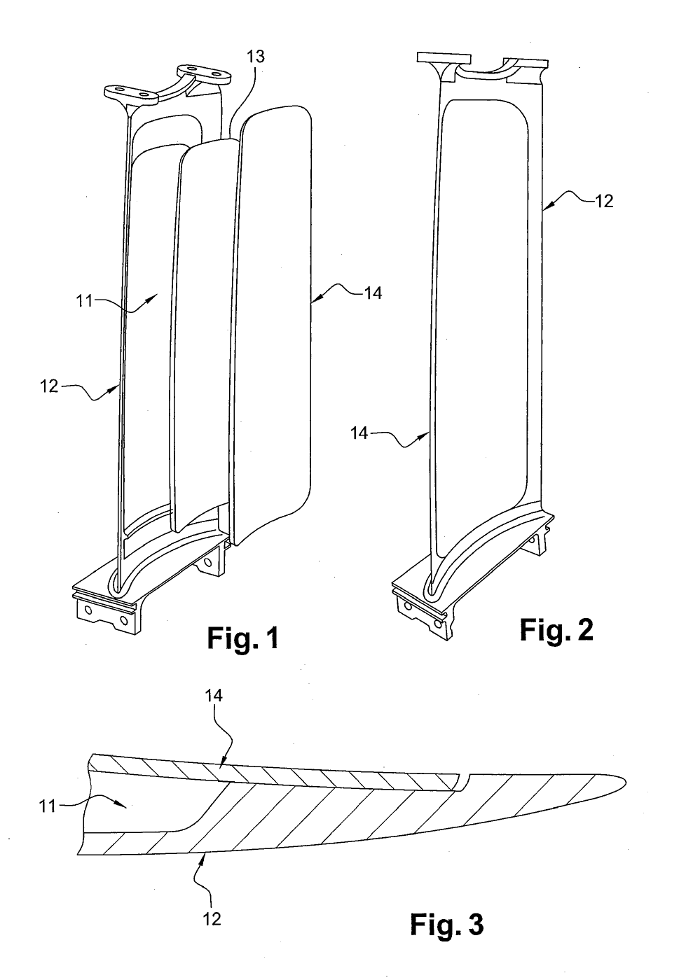

### DETAILED DESCRIPTION

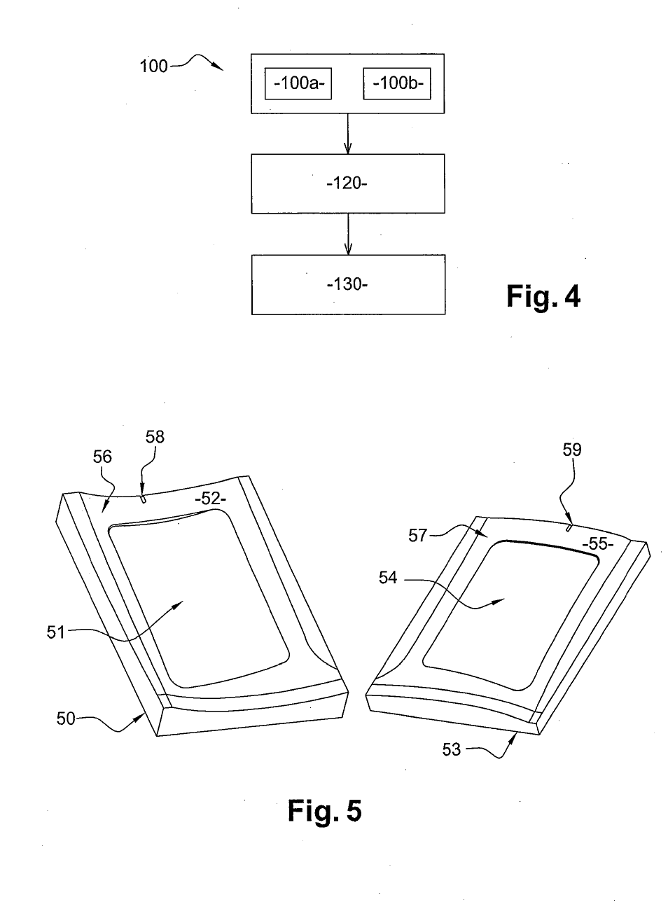

A method 100 for manufacturing a hollow structural vane according to an embodiment of the invention, comprising four procedures, illustrated by the diagram from FIG. 4:

a procedure 110a, illustrated in FIG. 5, of machining a first rough block 50, so as to form a first cavity 51 in a first face 52 of the first block 50;

a procedure 110b, also illustrated in FIG. 5, of machining a second rough block 53, so as to form a second cavity 54 in a second face 55 of the second block 53;

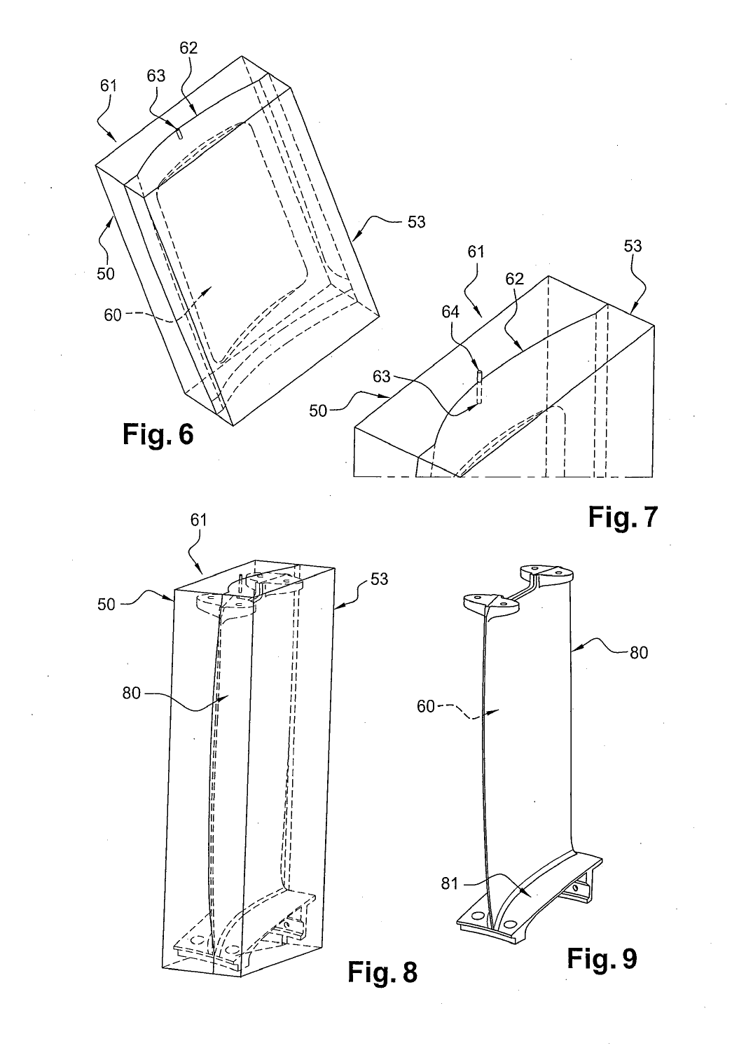

a procedure 120, illustrated in FIG. 6, of assembling the first block 50 and the second block 53, the first face 52 of the first block being positioned facing the second face 55 of the second block, the first cavity 51 of the first block 50 and the second cavity 54 of the second block 53 thus forming a closed cavity 60;

a procedure 130, illustrated in FIG. 8, of conventional machining that is well known to the person skilled in the art, of the block 61 resulting from the assembly of the first block 50 and the second block 53, so as to obtain a vane 80 comprising the closed cavity 60. It is noted that vane 80 shown from FIG. 8, inside the resulting block 61, is only represented as an aid in understanding the machining procedure 130.

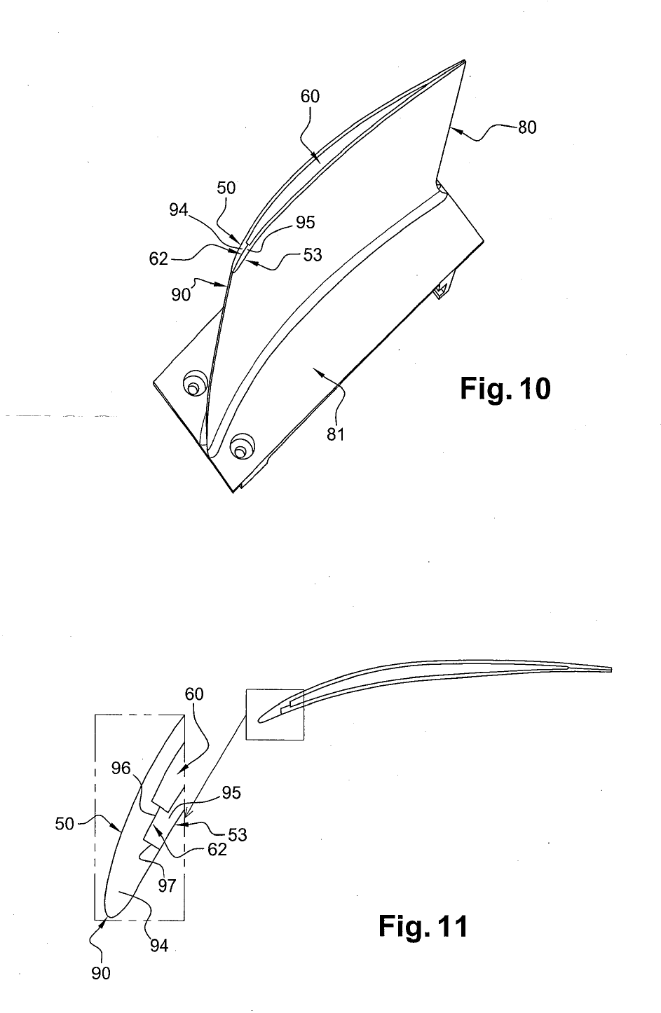

The vane 80 resulting from method 100 is represented in FIGS. 9 and 10.

It is noted that procedure 110b of machining the second rough block 53 so as to form the second cavity 54 is not essential, but is present in an embodiment of the invention in order to obtain the largest possible closed cavity 60. In fact, block 61 resulting from the assembly of the first block 50 and the second block 53 comprises a closed cavity, even if the second cavity 54 was not machined.

It is also noted that the formation of the first cavity 51 and/or second cavity 54 is not limited to an embodiment by machining; the cavities may be formed by other means or devices.

The first block 50 represented in FIG. 5 corresponds to the intrados of vane 80, while the second block 53 corresponds to the extrados. After the machining procedure 110a, the first face 52 of the first block 50 comprises the first cavity 51, surrounded by a first concave sealing surface 56. In addition, after the machining procedure 110b, the second face 55 of the second block 53 comprises the second cavity 54, surrounded by a second convex sealing surface 57. The first sealing surface 56 and the second sealing surface 57 are machined so as to present complementary forms in order to be joined and assembled. In the rest of the description, the mounting surface 62 will be called the contact surface between the first sealing surface 56 and the second sealing surface 57.

The block 61 resulting from the assembly of the first block 50 and the second block 53 is then conventionally machined, in a manner known to the person skilled in the art, to obtain the vane 80 represented in FIG. 9. By machining the resulting block 61, defects connected to the assembly, for example weld beads, are removed. Thus, the air flow along vane 80 is no longer disrupted. It is noted that the assembly is carried out by diffusion bonding, for example brazing, electron bombardment welding (E.B.), or by linear friction welding, that are assembly methods well known to the person skilled in the art.

It is noted that the size of closed cavity 60 is not limited by the mounting surface of a plate on a vane, as was the case in hollow vane manufacturing methods according to the prior art.

In an embodiment, the closed cavity 60 substantially follows the profile of vane 80. In other words, the thickness of the intrados and extrados walls is constant, as shown in FIG. 10. For this reason, the first cavity 51 has a concave form and the bottom of the second cavity 54 has a convex form. In this configuration, the volume of the closed cavity 60 is maximum, which enables an optimal weight savings. In addition, the closed cavity 60 is then equally distributed inside vane 80, which enables a balanced distribution of the mass of the vane.

In addition, in an embodiment, the method beneficially comprises procedures prior to the assembly 120, including:

forming a first groove 58 on an upper part of the first face 52 of the first block 50, and

forming a second groove 59 on an upper part of the second face 55 of the second block 53,

the first groove 58 and second groove 59 being positioned facing each other during the assembly 120 of the first block 50 and the second block 53, so as to form a throat 63.

The procedure 130 of machining the resulting block 61 then beneficially comprises sub-procedures of:

positioning a gauge, represented in FIG. 7, in the throat 63 formed by the first groove 58 and the second groove 59;

palpating gauge 64 by a machining tool used during the procedure 130 of machining the resulting block 61.

This facilitates locating the closed cavity 60 that is found inside the resulting block 61. The closed cavity 60 is represented in FIG. 10 in a cross sectional view of vane 80. Locating the closed cavity 60 enables the resulting block 61 to be machined precisely to obtain a vane 80 with constant intrados and extrados wall thickness, and the thickness of the leading edge 90 and trailing edge is sufficient to respect the mechanical strength stresses of the structural vane 80 subjected to engine loads. The leading edge thickness 90 is referred to as the minimum distance Ep1 between the leading edge 90 and the closed cavity 60, represented in FIG. 10. In addition, the trailing edge thickness is referred to as the minimum distance Ep2 between the trailing edge and the closed cavity 60, represented in FIG. 10.

It is noted that in a non-limiting embodiment, throat 63 is also an entry point for a filling material introduced in the closed cavity 60 by using an injection pistol. The filling material is, for example, foam, and is intended to counter the vibrational modes of vane 80.

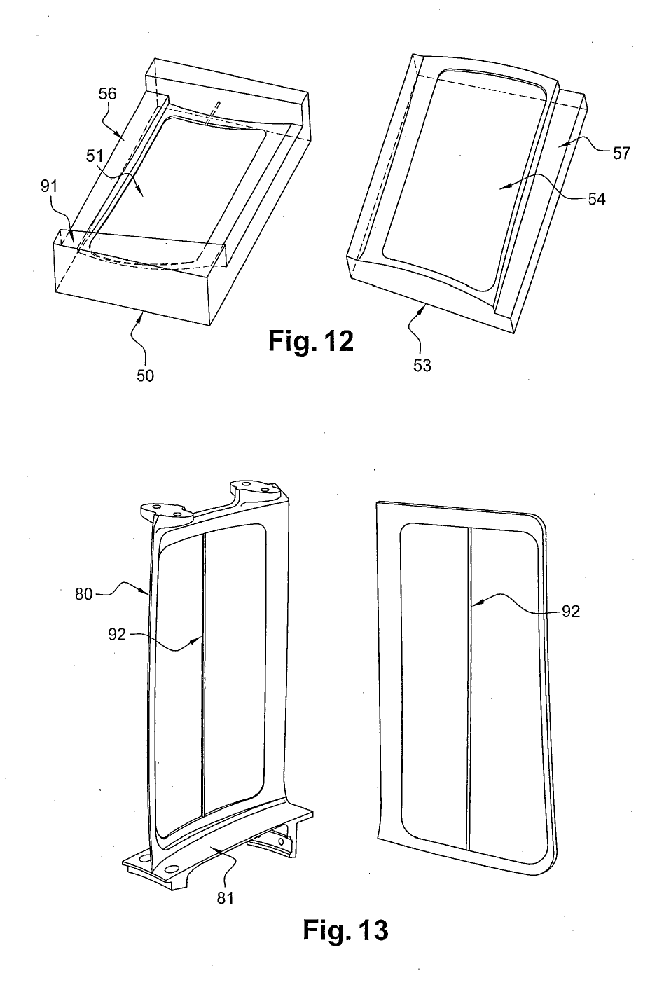

In addition, as represented in FIG. 10, it is noted that vane 80 resulting from method 100 comprises a leading edge 90 constituted of a junction, at the level of the mounting surface 62, between a first end part 94 of the first block 50, and a second end part 95 of the second block 53. Such being the case, as leading edge 90 is an area where many more impacts are likely to occur, protecting the leading edge is desirable. Therefore, in another non-limiting embodiment, the first block 50 and the second block 53 are machined such that the leading edge 90 of vane 80 does not contain the mounting surface 62, as illustrated in FIG. 11. The leading edge 90 is then exclusively constituted of a first end part 94 of the first block 50, the first end part 94 covering the second end part 95 of second block 53 such that the leading edge 90 presents a continuous surface. In this embodiment, the mounting surface 62 presents, on the leading edge side, a step-like form. In fact, instead of extending continuously to the leading edge 90, as was the case in the previously described embodiment represented in FIG. 10, the mounting surface 62 extends along a first plane 96 in the direction of the leading edge 90, and then along a second plane 97 that is substantially perpendicular to the first plane 96, up to the intrados surface of vane 80.

On the other hand, to maintain the structural aspect of a stator 80 formed via method 100 according to an embodiment of the invention, the stator 80 conventionally comprising a platform 81, the first block 50 (or else the second block 53) is machined so as to comprise at least one projecting part 91 extending substantially orthogonally to the plane according to which the first block 50 (or else the second block) extends. This is shown in FIG. 12. The platform 81 of stator 80 is then machined in the first block 50 (or else the second block 53) during the procedure of machining the resulting block 61.

Lastly, the method 100 beneficially comprises the procedures of producing a stiffener or stiffeners 92 in the first block 50 and/or in the second block 53, as represented in FIG. 13. A stiffener 92 is in fact useful to prevent buckling or for frequency setting the vane 80. It is noted that the presence of filling material in the closed cavity 60 is not necessary when the intrados and extrados of vane 80 are ribbed by a stiffener 92.

The method 100 described therefore enables a hollow vane 80, preferentially a turbomachine fan stator, to be manufactured, that presents a low midpoint diameter (low thickness) and good mechanical strength to the air flow, and that presents a substantially continuous external surface, i.e., a surface that does not present welding defects such as weld beads.

1. A method for manufacturing a hollow structural turbomachine vane, the method comprising:
forming a first cavity in a first face of a first block;
assembling by diffusion bonding the first block and a second block, the first face of the first block being positioned facing a second face of the second block, the first cavity thus forming a closed cavity;
machining the block resulting from the assembly of the first block and the second block so as to obtain a vane comprising the closed cavity.

2. The method according to claim 1, comprising, prior to the assembling, forming a second cavity in the second face of the second block, the first cavity and the second cavity facing each other during the assembling.

3. The method according to claim 2, wherein forming the first cavity in the first face of the first block is carried out by machining.

4. The method according to claim 2, wherein a profile of a closed cavity and a profile of the vane are substantially identical.

5. The method according to claim 2, comprising prior to the assembling:
forming a first groove on an upper part of the first face of the first block, and
forming a second groove on an upper part of the second face of the second block,
said first groove and second groove being positioned facing each other during the assembling of the first block and the second block, so as to form a throat.

6. The method according to claim 5, comprising prior to machining the resulting block:
placing a gauge in the throat;
palpation of the gauge by a machining tool.

7. The method according to claim 1, wherein the assembly by diffusion bonding is carried out by one of the following techniques:
brazing;
electron bombardment welding;
linear friction welding.

8. The method according to claim 1, comprising machining a first end part of the first block and a second end part of the second block, such that said first end part covers said second end part such that the leading edge presents a continuous surface.

9. The method according to claim 8, wherein a mounting surface between the first end part and the second end part presents a step-like form.

10. The method according to claim 1, comprising machining at least one projecting part in the first block, said at least one projecting part extending substantially orthogonally to the plane along which the first block extends.

11. The method according to claim 10, comprising producing a stiffener in the first block and/or in the second block.

12. A vane for a turbomachine obtained by a method according to claim 1.
